(19) United States
(12) Patent Application Publication
(10) Pub. No.: US 2026/0281568 A1
(43) Pub. Date: Sep. 17, 2026

(54) CONTROL APPARATUS, CONTROL METHOD AND STORAGE MEDIUM

(71) Applicant: CANON KABUSHIKI KAISHA, Tokyo (JP)

(72) Inventor: MASAYA OHTAKE, Kanagawa (JP)

(21) Appl. No.: 19/554,363

(22) Filed: Mar. 2, 2026

(30) Foreign Application Priority Data
Mar. 11, 2025 (JP) 2025-038363

(51) Int. Cl. H04N 23/88; H04N 23/661; H04N 23/667

(52) U.S. Cl. CPC H04N 23/88; H04N 23/661; H04N 23/667

(57) ABSTRACT

One or more control apparatuses, control methods, and storage mediums are provided herein. At least one control apparatus selects a distribution target image from images captured by a plurality of image capturing apparatuses, and controls a color temperature setting value of at least one of a first image capturing apparatus and a second image capturing apparatus so that a difference value between (i) the color temperature setting value of the first image capturing apparatus that captures an image before switching the distribution target image and (ii) the color temperature setting value of the second image capturing apparatus that captures an image after switching the distribution target image becomes less than a threshold value, based on a selection of the distribution target image.

### BACKGROUND

### Field of the Technology

The present disclosure relates to one or more embodiments of control apparatuses, one or more embodiments of control methods, and one or more storage mediums.

### Description of the Related Art

Capturing moving images and still images (hereinbelow, integrally referred to also as an image or images as appropriate) in video production is performed in a photo studio in which the color and intensity of a light source are controlled, and white balance adjustment of an image capturing apparatus is performed to capture the image of an object with a good color. The white balance adjustment function is a function of estimating a color temperature in a space of an image capturing target to express the object by the color actually seen by our eyes. Examples of the adjustment functions of the color temperature include an automatic white balance adjustment function performed according to an algorithm in the image capturing apparatus such as a digital camera, and a manual white balance adjustment function performed based on a manual setting by a user.

The automatic white balance adjustment function is a function of automatically adjusting a color temperature by estimating the color temperature in an image capturing target space from an object within the image capturing range. Thus, in a case where the image capturing range is different, when the same object is located within the different image capturing ranges, there is a case where the object is expressed in a different color. In this case, in a case where an image of the same object is captured at different angles of view by a plurality of image capturing apparatuses, if the image capturing apparatus serving as a captured image acquisition source is switched, there may be a state where a viewer recognizes that the same object is displayed in a different color.

On the other hand, the manual white balance adjustment function is a function of manually setting the white balance adjustment value of the image capturing apparatus by a user. The manual white balance adjustment function is used in such a manner that a color temperature in an image capturing space is uniquely determined by controlling, for example, a light source in a photo studio, and the white balance adjustment value of the image capturing apparatus is fixed by the manual white balance adjustment function so that the color of the object becomes the same in any image capturing range. By using the manual white balance adjustment function in this way, the object may be displayed in the same color, even if the image capturing apparatus serving as the captured image acquisition source of the captured image is switched, in a case where the image of the same object is captured at different angles of view by the plurality of the image capturing apparatuses.

There are many types of photo studios, and in these years, with the improvement of a distribution environment of moving images and the like, not only video production companies but also individuals may easily produce videos in the photo studio. In addition, the studios respond to the spread of the requests or desires of the users, and a user may use a photo studio, for example, with glass walls surrounding all around the photo studio to emphasize the appearance. In such a studio, a situation may occur in which the color and intensity of the light source in the studio change by a light source outside the studio, even if a user tries to control the light source. With such a characteristic, in a case of a photo studio, for example, which sunlight enters from outside the studio, since the color temperature of the sunlight varies between day and night, a case where the change of the color temperature between day and night affects the captured image may occur if the image capturing apparatus is operating in the manual white balance adjustment mode.

As a method to deal with such a situation, for example, a method of capturing an image using the automatic white balance function may be considered. However, even if the color temperature of the image capturing apparatus may be made to follow the change of the color temperature outside the studio, the same object may be displayed in different colors because under a situation in which an image of the same object is captured at different angles of view by a plurality of image capturing apparatuses, the white balance shifts when the image capturing apparatus serving as an acquisition source of the captured image is switched.

To address the above, Japanese Patent Laid-open No. 2015-119436 describes a method of adjusting a white balance so that the color does not change between the plurality of image capturing apparatuses, by adjusting a second white balance correction value based on the brightness of an object acquired by a first image capturing unit.

However, with the method described in Japanese Patent Laid-open No. 2015-119436, there may be a case in which it is difficult to set an appropriate white balance correction value of the image capturing apparatus for the image distribution.

### SUMMARY

In consideration of the above, one or more aspects of the present disclosure are directed to one or more embodiments of techniques capable of more effectively reducing an amount of shift in white balance between a plurality of image capturing apparatuses under a situation in which images are captured while switching the plurality of image capturing apparatuses as appropriate.

According to one or more aspects of the present disclosure, at least one embodiment of a control apparatus may select a distribution target image from images captured by a plurality of image capturing apparatuses, and may control a color temperature setting value of at least one of a first image capturing apparatus and a second image capturing apparatus so that a difference value between (i) the color temperature setting value of the first image capturing apparatus that captures an image before switching the distribution target image and (ii) the color temperature setting value of the second image capturing apparatus that captures an image after switching the distribution target image becomes less than a threshold value, based on a selection of the distribution target image.

According to other aspects of the present disclosure, one or more additional control apparatuses, one or more control methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of at least one embodiment of a configuration of a distribution system according to one or more aspects of the present disclosure.

FIG. 2 is a diagram illustrating an example of at least one embodiment of a configuration of an image capturing apparatus according to one or more aspects of the present disclosure.

FIG. 3 is a diagram illustrating an example of at least one embodiment of a configuration of a client apparatus according to one or more aspects of the present disclosure.

FIG. 4 is a diagram illustrating an example of at least one embodiment of a configuration of a control apparatus according to one or more aspects of the present disclosure.

FIG. 5 is a functional block diagram illustrating an example of at least one embodiment of a functional configuration of the distribution system according to one or more aspects of the present disclosure.

FIG. 6 is a flowchart illustrating an example of at least one embodiment of processing of the distribution system according to one or more aspects of the present disclosure.

FIG. 7 is a diagram illustrating an example of at least one embodiment of a control result of color temperature setting values of a plurality of image capturing apparatuses according to one or more aspects of the present disclosure.

FIG. 8 is a flowchart illustrating an example of at least one embodiment of processing performed by a distribution system according to one or more aspects of the present disclosure.

FIG. 9 is a diagram illustrating an example of at least one embodiment of a control result of color temperature setting values of a plurality of image capturing apparatuses according to one or more aspects of the present disclosure.

FIG. 10 is a diagram illustrating an example of at least one embodiment of a control result of color temperature setting values of a plurality of image capturing apparatuses according to one or more aspects of the present disclosure.

FIG. 11 is a flowchart illustrating an example of at least one embodiment of processing performed by a distribution system according to one or more aspects of the present disclosure.

### DESCRIPTION OF THE EMBODIMENTS

Hereinbelow, with reference to the attached drawings, embodiments of the present disclosure will be described in detail.

In addition, in the present specification and drawings, components having substantially the same functional configurations are assigned the same numbers, and the duplicate descriptions thereof are omitted.

Further, the embodiments described below are merely examples to realize the present disclosure, and are to be modified and changed as appropriate depending on various conditions and configurations of the apparatuses to which the present disclosure is applied. Thus, the present disclosure should not be limited to the embodiments described below. Further, embodiments may be configured by combining parts of the embodiments described below as appropriate.

### One or More Embodiments

### System Configuration(s) of One or More Embodiments

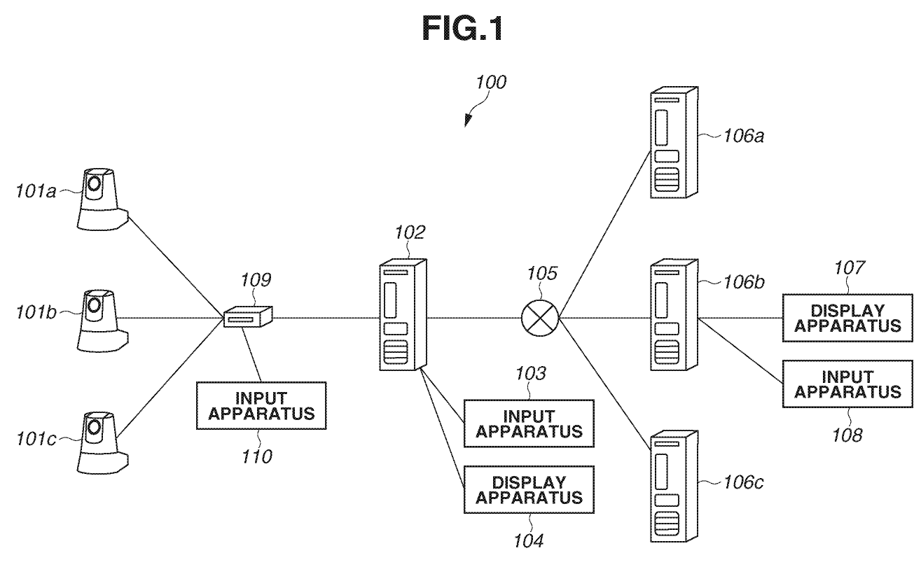

With reference to FIG. 1, an example of at least one embodiment of a configuration of a distribution system according to one or more aspects of the present disclosure will be described. A distribution system 100 includes a plurality of image capturing apparatuses 101a, 101b, and 101c (hereinbelow, also referred to as an image capturing apparatus 101 or image capturing apparatuses 101 as appropriate), a control apparatus 102, an input apparatus 103, a display apparatus 104, a network 105, a plurality of client apparatuses 106a, 106b, and 106c (hereinbelow, also referred to as a client apparatus 106 or client apparatuses 106 as appropriate), a display unit 107, an input apparatus 108, a switch 109, and an input apparatus 110.

For example, the number of the image capturing apparatuses 101 may be one, or the plurality of image capturing apparatuses 101 may be connected to the switch 109. In the example illustrated in FIG. 1, the configuration including the three image capturing apparatuses 101 (i.e., the image capturing apparatus 101a, the image capturing apparatus 101b, and the image capturing apparatus 101c) connected to the switch 109 is employed. Each of the image capturing apparatuses 101 transmits captured still images or moving images (hereinbelow, integrally referred to also as an image or images as appropriate) to the control apparatus 102 via the switch 109.

In one or more embodiments, various descriptions are given assuming that each of the image capturing apparatuses 101, and the control apparatus 102 are connected via local area network (LAN) cables as a connection method, but other connection methods may be employed. As another connection method, for example, a connection method based on a standard such as Serial Digital Interface (SDI) or High-Definition Multimedia Interface (HDMI®) may be employed. Further, as another example, a connection method based on a standard such as a wireless LAN or Universal Serial Bus Video Class (UVC) may be employed. In addition, in a case where the method of connection via the LAN cable is employed, a usage configuration form in which at most about 100 image capturing apparatuses 101 are connected to the control apparatus 102 may be assumed for one or more embodiments.

The input apparatus 103 and the display apparatus 104 are connected to the control apparatus 102. The input apparatus 103 is a user interface for receiving operations from a user. In one or more embodiments, a device usable for operating each of the image capturing apparatuses 101, such as a keyboard and a multi-directional input stick controller, may be employed. The display apparatus 104 is an output interface for presenting to a user various kinds of information by displaying them as images, and, for example, the display apparatus 104 may be used to display images captured by the image capturing apparatuses 101.

Further, the control apparatus 102 is connected with each of the client apparatuses 106 via the network 105. In this way, the images distributed from the control apparatus 102 may be viewed via each of the client apparatuses 106. The example in FIG. 1 illustrates a state where three client apparatuses 106a, 106b, and 106c (i.e., (client apparatuses 106) are connected to the network 105.

Further, the display unit 107 and the input apparatus 108 are connected to each of the client apparatuses 106 (the display unit 107 and the input apparatus 108 for other than the client apparatus 106b are not illustrated). Each of the client apparatuses 106 may issue an image distribution request to the control apparatus 102 via the network 105, and displays, in response to the image distribution request, a distribution image received from the control apparatus 102 on the display unit 107. The input apparatus 108 is an input interface used by a user to operate each of the client apparatuses 106, and, for example, a keyboard and a mouse may be used.

In a case where the connection method is, for example, a LAN, a network hub may be used as the switch 109, and in a case of HDMI, a distributor or the like may be used. Similar to the input apparatus 103, the input apparatus 110 is a user interface for receiving an operation from a user, and in one or more embodiments, a device usable for operating the image capturing apparatuses 101, such as a keyboard or a multi-directional input stick controller, may be employed.

In addition, the configuration illustrated in FIG. 1 is just an example, and it is not intended to limit the configuration of the distribution system 100 according to one or more embodiments. For example, in the example illustrated in FIG. 1, the client apparatuses 106, the display unit 107, and the input apparatus 108 are illustrated as separate apparatuses, but each of the client apparatuses 106, the display unit 107, and the input apparatus 108 may be integrally configured like a notebook personal computer (PC) including a touch panel display. Similarly, the input apparatus 103 and the display apparatus 104 are illustrated as separate apparatuses in FIG. 1, but the input apparatus 103 and the display apparatus 104 may be integrally configured like a controller integrally configured with a panel.

### Internal Configuration(s) of One or More Embodiments of an Image Capturing Apparatus

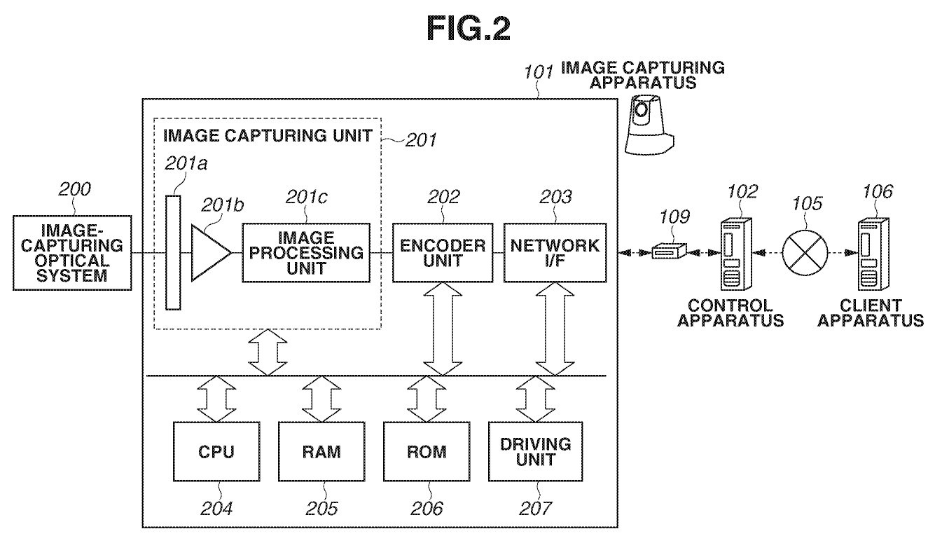

With reference to FIG. 2, an example of at least one embodiment of a configuration of the image capturing apparatus 101 according to one or more aspects of the present disclosure will be described. The image capturing apparatus 101 includes an image capturing unit 201, an encoder unit 202, and a network interface (I/F) 203. Further, the image capturing apparatus 101 includes a central processing unit (CPU) 204, a random access memory (RAM) 205, and a read only memory (ROM) 206. Further, an image-capturing optical system 200 is detachably attached to the image capturing apparatus 101.

The image-capturing optical system 200 is a lens unit for focusing light from an object on an imaging plane of an image sensor 201a described below, and may be configured of, for example, a zoom lens, a focus lens, and an image blur correction lens.

In addition, in one or more embodiments, the image capturing apparatus 101 and the image-capturing optical system 200 are configured separately to be attachable to and detachable from each other, but the image capturing apparatus 101 and the image-capturing optical system 200 may be integrally configured like a built-in lens camera.

The image capturing unit 201 captures an image of an object guided through the image-capturing optical system 200 to form an image. The image capturing unit 201 includes the image sensor 201a, an amplifier 201b, and an image processing unit 201c. The image capturing unit 201 may be configured to be able to set and change exposure parameters for each pixel group consisting of a plurality of pixels (e.g., 128 x 128 pixels) on the imaging plane of the image sensor 201a. The exposure parameters are parameters related to an exposure, and may include parameters such as an exposure period, an analog gain, and an exposure setting value.

The image sensor 201a converts the light from the object focused by the image-capturing optical system 200 on the imaging plane into an electrical signal for each pixel, and outputs the converted electrical signal. The image sensor 201a captures an image of the object for each pixel group with an exposure time based on the set exposure parameter. The image sensor 201a is realized as an integrated circuit (IC) chip with pixels composed of photoelectric conversion devices arranged in a matrix manner. As the image sensor 201a, for example, a charge coupled device (CCD) sensor or a complementary metal oxide semiconductor (CMOS) sensor may be used. For example, the image sensor 201a has high sensitivity mainly for visible light, and has high sensitivity for any one of Red (R), Green (G), and Blue (B) for each pixel, but may be configured to have some sensitivity to infrared light. Thus, in this case, the image sensor 201a may capture an image of the object brightly and clearly, for example, using sunlight during the time period in a case where sunlight is present, and using infrared light at a place illuminated by infrared light, or the like. In addition, the above-described at least one embodiment of a configuration is just an example, and the configuration of the image sensor 201a may be appropriately changed depending on the predictable image capturing target or the expected application scene.

The amplifier 201b amplifies the electrical signal output from the image sensor 201a, and outputs the amplified electrical signal. The amplifier 201b is provided for each pixel or each pixel group, and a signal amplification factor (analog gain) is set based on the exposure parameters for each pixel group.

The image processing unit 201c performs analog-to-digital (A/D) conversion of the electrical signal, which is an analog signal output from the amplifier 201b, into a digital signal, and generates a digital image by applying image processing including demosaicing processing, white balance processing, gamma processing, etc. The white balance processing includes at least two patterns of performing correction processing automatically based on an algorithm of the image capturing apparatus 101, and performing correction processing based on an instruction value given from outside the image capturing apparatus. As an external apparatus serving as an instruction source, for example, the control apparatus 102 may be used, and the client apparatus 106 may also be used. The image processing unit 201c corrects the brightness of the image by amplifying or attenuating the digital value of the image signal output from each pixel or each pixel group for each pixel or each pixel group. Further, the image processing unit 201c performs electronic image stabilization based on posture information of the image capturing apparatus 101 detected by a sensor unit (not illustrated). With the electronic image stabilization function, image blur correction is possible, and shift correction of the pan and tilt directions and angle correction in the roll direction are performed. As the sensor unit, for example, a gyro sensor is used, and may acquire the posture angle of the image capturing apparatus 101 by vector detection.

The encoder unit 202 performs encoding processing on the image data output from the image capturing unit 201 (image processing unit 201c) to convert the image data into data of a predetermined format.

Examples of the file format include, but are not limited to, Motion Jpeg, H264, and H265 for image data of a moving image.

The network I/F 203 transmits the image data with the encoding processing performed thereon by the encoder unit 202 to the client apparatus 106 via the network 105. In addition, the image data with the encoding processing performed thereon may be stored in an internal storage device such as the RAM 205 or the ROM 206 described below, or in a removable storage medium (not illustrated) such as a secure digital (SD) card. Further, the processing related to the storage of the image data may be performed after the image data is output from the image processing unit 201c. In this case, RAW data before being encoded is stored as the image data. Further, the network I/F 203 may receive operations and instructions from the control apparatus 102 or the client apparatus 106 to the image capturing apparatus 101 via the network 105. Examples of the operations and instructions received from the control apparatus 102 or the client apparatus 106 include setting changes of the functions of the image capturing apparatus 101.

The CPU 204 is a central processing unit for integrally controlling the image capturing apparatus 101.

The RAM 205 temporarily stores a computer program executed by the CPU 204. Further, the RAM 205 provides a work area used in a case where the CPU 204 performs processing. Further, the RAM 205 also functions as a frame memory and a buffer memory.

The ROM 206 stores programs and the like used by the CPU 204 for controlling the image capturing apparatus 101.

### Internal Configuration(s) of One or More Embodiments of a Client Apparatus

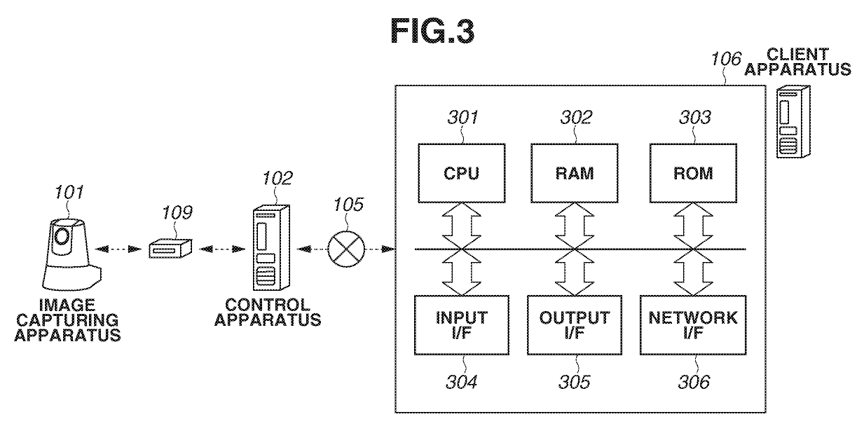

With reference to FIG. 3, an example of at least one embodiment of a configuration of the client apparatus 106 according to one or more aspects of the present disclosure will be described.

The client apparatus 106 is an information processing apparatus including a CPU 301, a RAM 302, a ROM 303, an input I/F 304, an output I/F 305, and a network I/F 306.

The CPU 301 is a central processing unit that integrally controls the client apparatus 106.

The RAM 302 provides a work area for temporarily storing a program or the like used by the CPU 301 for controlling the client apparatuses 106.

The ROM 303 stores programs and the like used by the CPU 301 for controlling the client apparatus 106.

The input I/F 304 is an interface connected with the input apparatus 108 illustrated in FIG. 1 to receive an operation input from a user to the client apparatus 106 via the input apparatus 108.

The output I/F 305 is an interface connected with the display unit 107 illustrated in FIG. 1 to display the image output from the image capturing apparatus 101 on the display unit 107.

The network I/F 306 is an interface connected with the image capturing apparatus 101 via the network 105 to input operation information to the image capturing apparatus 101, and to receive the image output from the image capturing apparatus 101.

### Internal Configuration(s) of One or More Embodiment of a Control Apparatus

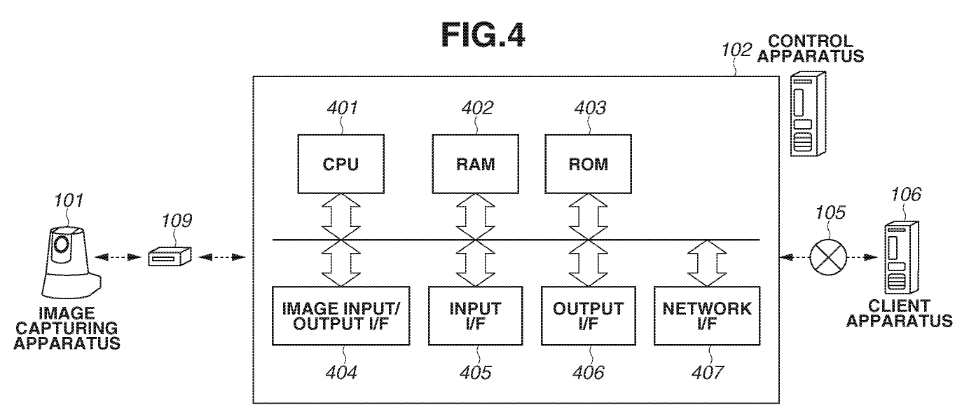

With reference to FIG. 4, an example of at least one embodiment of a configuration of the control apparatus 102 according to one or more aspects of the present disclosure will be described. The control apparatus 102 is an information processing apparatus including a CPU 401, a RAM 402, a ROM 403, an image input/output I/F 404, an input I/F 405, an output I/F 406, and a network I/F 407.

The CPU 401 is a central processing unit for integrally controlling the control apparatus 102.

The RAM 402 provides a work area for temporarily storing a program used by the CPU 401 for controlling the control apparatus 102 and/or for controlling images and/or other input from the image capturing apparatus 101.

The ROM 403 stores programs used by the CPU 401 for controlling the control apparatus 102 and/or for controlling the images and/or other input from the image capturing apparatus 101.

The image input/output I/F 404 is an interface for connecting the control apparatus 102 to the image capturing apparatus 101 via a predetermined transmission path or the network 105. Examples of the transmission path and the network for connecting the image input/output I/F 404 to the image capturing apparatus 101 include a LAN cable, an HDMI cable, an SDI cable, a wireless LAN, and a universal serial bus (USB) cable. The image input/output I/F 404 receives captured images from the image capturing apparatus 101. Further, the image input/output I/F 404 serves as an interface used in a case where the control apparatus 102 issues an instruction by a setting value to the image capturing apparatus 101, or performs a status confirmation or the like of the image capturing apparatus 101.

The input I/F 405 is an interface connected with the input apparatus 103 to receive operations input to the control apparatus 102 from a server administrator via the input apparatus 103.

The output I/F 406 is an interface connected with the display apparatus 104 to display thereon images output from the image capturing apparatus 101.

The network I/F 407 is an interface for connecting the control apparatus 102 to the network 105. The image captured by the image capturing apparatus 101 and input to the control apparatus 102 is distributed to the client apparatus 106 via the network 105. Further, the network I/F 407 also functions as an interface for receiving an image distribution request from the client apparatus 106, and distributing the image to the client apparatus 106.

### Functional Configuration(s) of One or More Embodiments

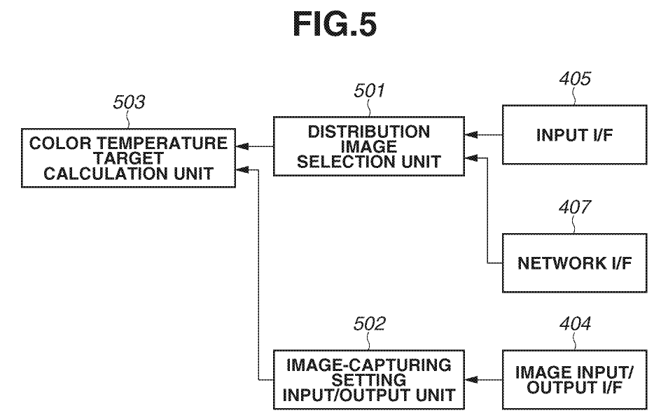

With reference to FIG. 5, an example of at least one embodiment of a functional configuration of the distribution system 100 according to one or more aspects of the present disclosure will be described.

Functional blocks illustrated in FIG. 5 may be mounted on any of the control apparatus 102 and the client apparatus 106 in the distribution system 100.

For each of the functions implemented by software, a corresponding program is stored in at least one of the ROM 303 and the ROM 403. Then, each of the corresponding functions is implemented by at least one of the CPU 301 and the CPU 401 reading the program into at least one of the RAM 302 and the RAM 402, and executing the read program.

Each of the functions implemented by hardware in one or more embodiments may be implemented by a field programmable gate array (FPGA) reading data from at least one of the ROM 303 and the ROM 403, and generating a circuit. Further, each of the functions may be implemented by hardware by forming a gate array circuit in a similar manner to the FPGA.

Further, each of the functions described above may be implemented by an application specific integrated circuit (ASIC).

In addition, the functional configuration illustrated in FIG. 5 is just an example, and a plurality of functional blocks may configure one functional block, or any of the functional blocks may be divided into blocks each performing a function. The input I/F 405 and the network I/F 407 illustrated in FIG. 5 respectively correspond to the input I/F 304 and the network I/F 306 illustrated in FIG. 3, and the image input/output I/F 404 performs control corresponding to the control performed by the input I/F 304 and the output I/F 305.

A distribution image selection unit 501 selects an image to be displayed on the client apparatus 106, the display apparatus 104, or the display unit 107 from among the images acquired by the image capturing apparatuses 101 (e.g., the image capturing apparatus 101a, the image capturing apparatus 101b, and the image capturing apparatus 101c). In addition, in one or more embodiments, for convenience, various descriptions are given assuming that an image captured by an image capturing apparatus is selected, but images captured by a plurality of image capturing apparatuses may be selected, and after the selected images are combined or superimposed, the result may be distributed. In addition, for example, a user may select which images are to be a combination target or a superimposition target. In this case, for example, the selection may be performed by receiving an operation to the input apparatus 103 via the input I/F 405, or may be performed by an input signal received from the input apparatus 108 via the network I/F 407.

In addition, other than the user, an application mounted on the control apparatus 102 or the client apparatus 106 may select the image. Examples of the application may include an application for automatic distribution control by face recognition or scene identification. In this case, for example, in a case where the application performs switching determination of the image to be selected using a given threshold value set in the application, the image may be selected.

An image-capturing setting input/output unit 502 writes a setting value into the target image capturing apparatus 101 (e.g., the image capturing apparatus 101a, the image capturing apparatus 101b, or the image capturing apparatus 101c illustrated in FIG. 1), and reads the status of each of the image capturing apparatuses 101 or the input setting values or the like.

A color temperature target calculation unit 503 calculates a color temperature setting value of the target image capturing apparatus 101 (e.g., the image capturing apparatus 101a, the image capturing apparatus 101b, or the image capturing apparatus 101c illustrated in FIG. 1). For example, in one or more embodiments, the color temperature setting value of the target image capturing apparatus 101 is calculated based on the difference value between the color temperature setting values of the two image capturing apparatuses 101 before and after the switching of the distribution image, including the target image capturing apparatus 101 from among the image capturing apparatus 101a, the image capturing apparatus 101b, and the image capturing apparatus 101c. In a case where the color temperature setting value is set to each of the target image capturing apparatuses 101, each of the image capturing apparatuses 101 changes the white balance based on the set value.

### Operation(s) that may be used in One or More Embodiments

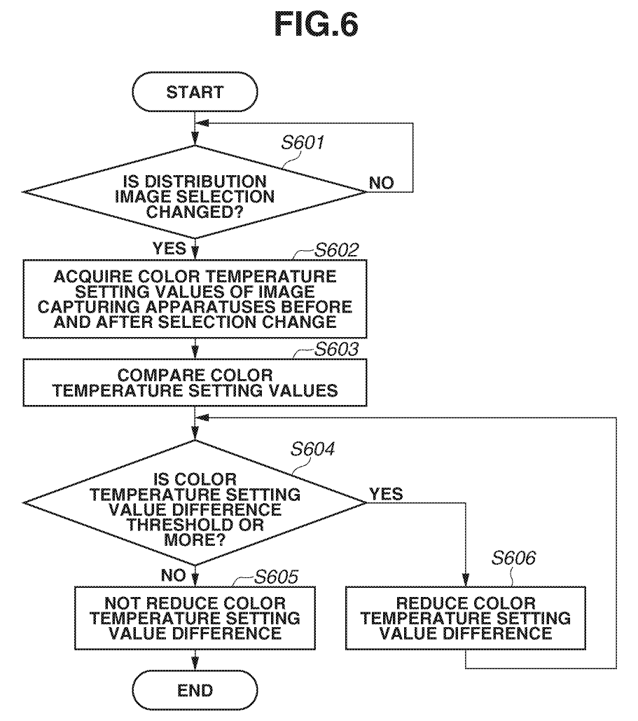

With reference to FIG. 6, an example of at least one embodiment of processing performed by the distribution system 100 according to one or more aspects of the present disclosure will be described. A series of the processes illustrated in FIG. 6 is implemented by the CPU 301 or the CPU 401 executing a program stored in the ROM 303 or the ROM 403 and loaded into the RAM 302 or the RAM 402. Further, in the example illustrated in FIG. 6, assume that each of the image capturing apparatuses 101 is operating using the automatic white balance adjustment function in a case where the series of processes starts.

Further, in one or more embodiments of the present disclosure, the automatic white balance adjustment refers to an operation performed in an operation mode in which the image capturing apparatus 101 determines the image-capturing environment (in particular, the state of light) each time to set the color temperature automatically so that an appropriate color tone may be reproduced. Further, the manual white balance adjustment refers to an operation performed in an operation mode in which a color temperature is set based on an instruction given from the outside such as a user and other applications.

In step S601, the distribution image selection unit 501 determines whether the selection of the distribution image is changed by the input I/F 405, the network I/F 407, or the application executed by the CPU 301 or the CPU 401.

The distribution image selection unit 501 repeats the determination in step S601 until the selection of the distribution image is changed (NO in step S601).

Then, in step S601, in a case where the distribution image selection unit 501 determines that the selection of the distribution image is changed (YES in step S601), the processing proceeds to step S602.

In step S602, the image-capturing setting input/output unit 502 acquires the color temperature setting value set on the image capturing apparatus 101 via the image input/output I/F 404. At this time, the image-capturing setting input/output unit 502 acquires the color temperature setting values from the image capturing apparatuses 101 before and after the selection change of the distribution image.

In step S603, the color temperature target calculation unit 503 compares the color temperature setting values before and after the selection change of the distribution image acquired in step S602, to calculate a difference value.

In step S604, the color temperature target calculation unit 503 determines whether the difference value between the color temperature setting values calculated in step S603 is a given threshold value or more.

In step S604, in a case where the color temperature target calculation unit 503 determines that the difference value between the color temperature setting values is the threshold value or more (YES in step S604), the processing proceeds to step S606.

On the other hand, in step S604, in a case where the color temperature target calculation unit 503 determines that the difference value between the color temperature setting values is less than the threshold value (NO in step S604), the processing proceeds to step S605.

In addition, the given threshold value used in step S604 may be set, for example, by an instruction from a user via the input apparatus 103 or the input apparatus 108. Further, as another example, the given threshold value may be changed by an application executed by the CPU 301 or the CPU 401 based on the image-capturing scene. In this case, for example, the threshold value may be stored as a table value in advance.

In step S605, since the difference value between the color temperature setting values is less than the threshold value, the image-capturing setting input/output unit 502 does not input the color temperature setting value to the image capturing apparatus 101, and ends the series of processes illustrated in FIG. 6 in one or more embodiments. Then, the image capturing apparatus 101 continues operating in the automatic white balance adjustment mode.

In step S606, since the difference value between the color temperature setting values is the threshold value or more, the image-capturing setting input/output unit 502 provides a setting instruction of the color temperature setting value to the image capturing apparatus 101 so as to reduce the difference value between the color temperature setting values of the image capturing apparatuses 101. In this case, the image capturing apparatus 101 before or after the setting of the color temperature setting value stops the operation of the automatic white balance adjustment, and performs the operation in the manual white balance adjustment mode following the setting instruction of the color temperature setting value. Then, the image-capturing setting input/output unit 502 returns the processing to step S604.

In addition, the color temperature target calculation unit 503 and the image-capturing setting input/output unit 502 correspond to an example of a control unit for controlling the setting of the color temperature of the image capturing apparatus 101.

In addition, as for a control interval for reducing the difference value between the color temperature setting values, a fixed change width may be used, or a control to update the color temperature setting value, for example, in time-series on a frame-by-frame basis may be used. Further, as another example, the control interval for reducing the difference value between the color temperature setting values may be variable, and a change width (i.e., the change width in the color temperature setting value per control unit) of the color temperature setting value used in a case where the color temperature setting value is changed may also be variable.

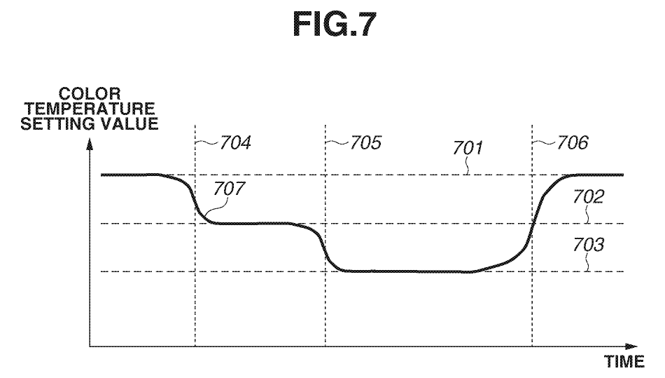

For example, the color temperature target calculation unit 503 may change the color temperature setting value while sequentially changing the change width of the color temperature setting value in time-series so that the color temperature setting value changes more gradually and continuously in time-series within the range in which the change width of the color temperature setting value does not exceed the threshold value. Further, as another example, the color temperature target calculation unit 503 may change the color temperature setting value while sequentially changing the control interval of the color temperature setting value in time-series so that the color temperature setting value changes more gradually and continuously in time-series within the range in which the change width of the control interval of the color temperature setting value does not exceed the threshold value. As a specific example, in an example illustrated in FIG. 7, in a case where the change of the color temperature setting value over time is expressed as a graph, the color temperature setting value is changed in time-series so as to form an S-shaped curve. Further, as yet another example, the update timing or the change width of the color temperature setting value may be a given variable value, or may be changed by a designation from a user.

### Effect(s) of or for features that may be used in One or More Embodiments

With reference to FIG. 7, at least one embodiment of an effect of the operation of the distribution system 100 according to one or more aspects of the present disclosure will be described. In FIG. 7, the color temperature setting values, in a case where each of the image capturing apparatuses 101 operates in the automatic white balance mode, of the corresponding image capturing apparatuses 101 are illustrated by broken lines. More specifically, a color temperature setting value 701 illustrates the color temperature setting value of the image capturing apparatus 101a in a case where the image capturing apparatus 101a operates in the automatic white balance mode. Similarly, a color temperature setting value 702 illustrates a color temperature setting value of the image capturing apparatus 101b. Further, a color temperature setting value 703 illustrates a color temperature setting value of the image capturing apparatus 101c.

Further, in FIG. 7, the switching timings of the distribution image are illustrated in dotted lines. For example, at an image distribution switching timing 704, the image distribution source is switched from the image capturing apparatus 101a to the image capturing apparatus 101b. Similarly, at an image distribution switching timing 705, the image distribution source is switched from the image capturing apparatus 101b to the image capturing apparatus 101c. Further, at an image distribution switching timing 706, the image distribution source is switched from the image capturing apparatus 101c to the image capturing apparatus 101a.

In a case where the control that may be used in one or more embodiments is not used, since the color temperature setting values of the image capturing apparatuses 101 before and after the switching of the distribution image have a shift, and the white balance is shifted at each of the distribution image switching timings, a phenomenon in which the color of the distribution image sharply changes may occur. Such a phenomenon may be perceived by a viewer as being unnatural.

On the other hand, the control that may be used in one or more embodiments reduces the difference value between the color temperature setting values of the image capturing apparatuses 101 before and after the switching of the distribution image by the manual white balance adjustment, as illustrated by a transition 707 of the color temperature setting value. By performing such a control, the shift of the white balance is reduced, and the change of the color of the distribution image becomes gentle. As a result, it may be expected that the viewer is less likely to feel the color change of the distribution image generated when the distribution image is changed unnatural.

In addition, in FIG. 7, the example of the case where the image capturing apparatus 101 before the switching of the distribution image is driven in the manual white balance mode is described, but a control of driving the image capturing apparatus 101 after the switching of the distribution image in the manual white balance adjustment mode may be used.

As described above, in at least one embodiment of the distribution system 100 according to one or more aspects of the present disclosure, the control to reduce the difference value between the color temperature setting values of the image capturing apparatuses 101 before and after the switching of the distribution image at the switching timing of the distribution image is performed. By using such a control, for example, the effect may be expected that the shift of the white balance is reduced in a case where the distribution image is switched between the plurality of image capturing apparatuses 101 while reducing the influence of a change in external light from outside the studio using the automatic white balance adjustment.

### One or More Additional Embodiments

One or more additional embodiments according to the present disclosure will be described below. In addition, since configurations of the distribution system 100 including the image capturing apparatuses 101 according to one or more additional embodiments and the image capturing apparatuses 101 according to the one or more additional embodiments are similar to those according to one or more aforementioned embodiments, detailed descriptions thereof are omitted.

### Operation(s) that may be used in One or More Additional Embodiments

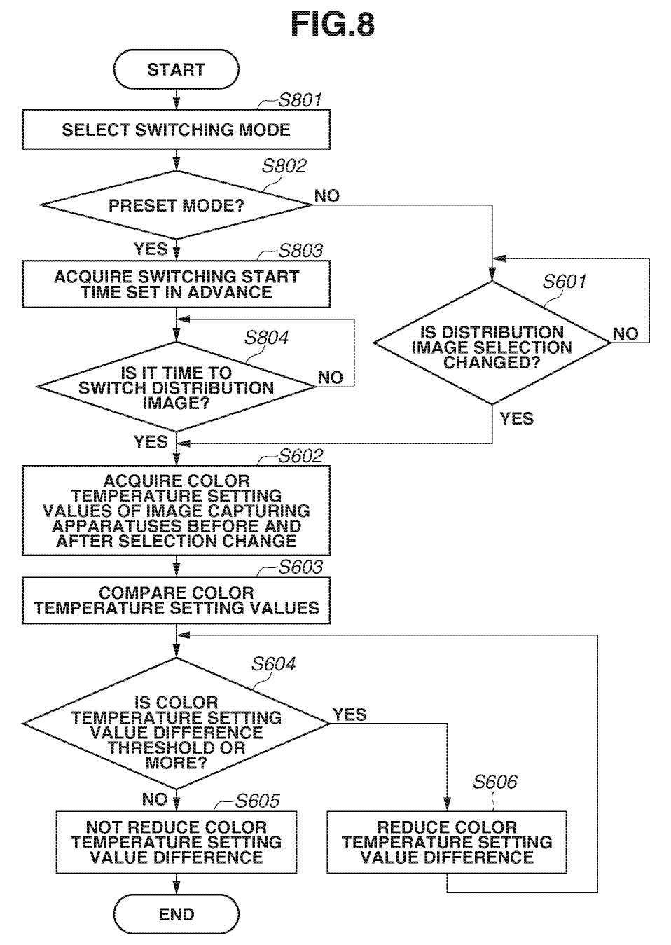

With reference to FIG. 8, an example of processing performed by the distribution system 100 of one or more additional embodiments will be described. A series of the processes illustrated in FIG. 8 is implemented by the CPU 301 or the CPU 401 executing a program stored in the ROM 303 or the ROM 403 and loaded into the RAM 302 or the RAM 402. In addition, detailed descriptions of the processing substantially the same as the processing in the example illustrated in FIG. 6 are omitted.

In step S801, the distribution image selection unit 501 changes the operation mode. The application target operation modes may include at least two operation modes, which are a mode referred to as a preset mode and a mode referred to as a manual mode.

The manual mode is a mode in which a user manually determines the switching timing of the distribution image each time. In the manual mode, for example, the switching of the distribution image by the input apparatus 103 via the input I/F 405, and the switching of the distribution image by an input signal from the input apparatus 108 via the network I/F 407 may be performed. Further, not limited to the instruction from a user, and, for example, the distribution image may be selected by an instruction from an application mounted on the control apparatus 102 or the client apparatuses 106. Examples of the application may include an application of automatic distribution control by face recognition or scene identification. In this case, for example, in a case where the application performs switching determination of the image to be selected based on a given threshold value set in the application, the image is selected.

The preset mode is a mode in which the distribution image is switched to an image acquired by the image capturing apparatus 101 set as a switching target using an event set in advance as a starting point (e.g., triggered in a case where a predetermined condition is satisfied). As a specific example, in the preset mode, the distribution image may be switched to the image captured by the image capturing apparatus 101 set as the switching target by using an elapse of a time set in advance as a trigger. Further, in the preset mode, other than the time, the distribution image may be switched by using a change in the image such as an action of an object, as a trigger. For example, these modes may be selected by the input apparatus 103 via the input I/F 405, or may be selected based on an input signal from the input apparatus 108 via the network I/F 407.

In step S802, the distribution image selection unit 501 determines which mode is selected as an operation mode from between the preset mode and the manual mode.

In step S802, in a case where the distribution image selection unit 501 determines that the preset mode is selected (YES in step S802), the processing proceeds to step S803.

On the other hand, in step S802, in a case where the distribution image selection unit 501 determines that the manual mode is selected (NO in step S802), the processing proceeds to step S601. In addition, processing performed in step S601 and the subsequent steps are similar to those performed in the example described above with reference to FIG. 6. More specifically, the distribution image selection unit 501 starts the control of reducing the difference value between the color temperature setting values of the image capturing apparatuses 101 before and after the switching of the distribution image, using the timing of receiving the instruction from the user as a starting point, in a case where the distribution system 100 is operating in the manual mode.

In step S803, the distribution image selection unit 501 acquires the switching time of the distribution image set in advance. In addition, as for the switching time, a plurality of switching times may be set, and in this case, the distribution image selection unit 501 acquires the set number of switching times.

In step S804, the distribution image selection unit 501 determines whether the switching time of the distribution image has been reached. The distribution image selection unit 501 waits until the switching time of the distribution image has been reached, as long as the distribution image selection unit 501 determines that the switching time of the distribution image has not been reached (NO in step S804). Then, in a case where the distribution image selection unit 501 determines that the switching time of the distribution image has been reached (YES in step S804), the processing proceeds to step S602. In addition, processing performed in step S602 and the subsequent steps are similar to those performed in the example described above with reference to FIG. 6.

### Effect(s) of or for features that may be used in One or More Additional Embodiments

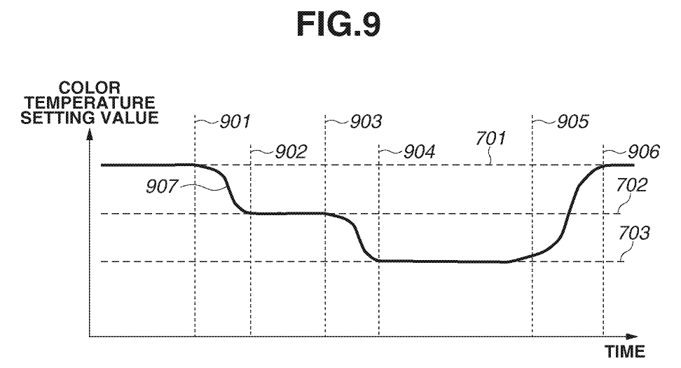

With reference to FIG. 9, an effect obtained when the distribution system 100 according to one or more additional embodiments operates in the manual mode will be described. In addition, the same objects in FIG. 9 as those in the example illustrated in FIG. 7 are assigned the same numbers as those in FIG. 7. Thus, detailed descriptions of the objects assigned the same numbers as those in the example in FIG. 7 are omitted.

Each of switching start timings 901, 903, and 905 illustrated in a dotted line indicates a timing at which a switching instruction of the distribution image is issued by a user. Further, each of switching completion timings 902, 904, and 906 illustrated in a dotted line indicates a timing at which the switching of the distribution image is completed. In the example illustrated in FIG. 9, the switching of the distribution image is performed at the timings described above. More specifically, the distribution image is switched during the time period between the switching start timing 901 and the switching completion timing 902. The switching is performed during the time period between the switching start timing 903 and the switching completion timing 904, and during the time period between the switching start timing 905 and the switching completion timing 906, in the same manner as the switching described above. Hereinbelow, various descriptions are given referring to the period from the switching start timing to the switching completion timing as a switching in-progress period, for convenience.

Further, until the switching completion timing 902, the image captured by the image capturing apparatus 101a is selected as the distribution image, and then the distribution image is switched to the image captured by the image capturing apparatus 101b. In a similar manner, until the switching completion timing 904, the image captured by the image capturing apparatus 101b is selected as the distribution image, and then the distribution image is switched to the image captured by the image capturing apparatus 101c. Further, until the switching completion timing 906, the image captured by the image capturing apparatus 101c is selected as the distribution image, and then the distribution image is switched to the image captured by the image capturing apparatus 101a.

Further, assume that a user determines the switching destination of the image after checking the image of the switching destination in a case where the distribution image is switched, and then issues the switching start instruction. Thus, assume that all the image capturing apparatuses 101 are driven in the automatic white balance mode before the start of the switching, and, during the switching in-progress period, processing to make the color temperature setting value of the image capturing apparatus 101 before the start of the switching closer to the color temperature setting value of the switching destination image capturing apparatus 101 is performed based on the instruction of the control apparatus 102 or the like. A transition 907 of the color temperature setting value illustrates a transition of the color temperature setting value of the distribution image at this time.

At this time, after the switching timings exemplified as the switching start timings 901, 903, and 905, the color temperature setting value of the switching start destination image capturing apparatus 101 may be controlled so that the color temperature setting value of the switching start destination image capturing apparatus 101 approaches the color temperature setting value set in the image capturing apparatus 101 before the start of the switching. With the application of such a control, the distribution image may be switched more quickly to the image captured by the switching destination image capturing apparatus 101.

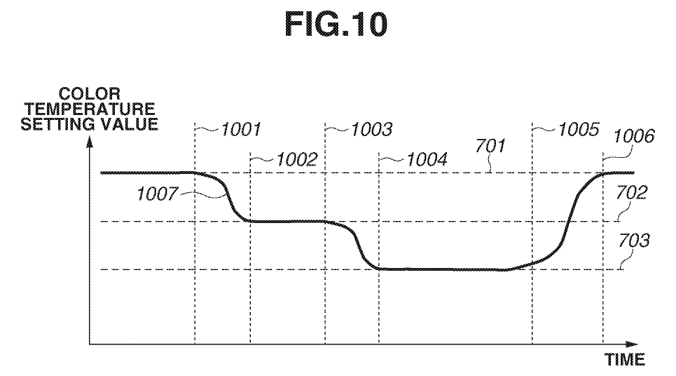

With reference to FIG. 10, an effect or effects of the distribution system 100 according to one or more additional embodiments operating in the preset mode will be described. In addition, objects illustrated in FIG. 10 the same as those in the example illustrated in FIG. 7 are assigned the same numbers as those in FIG. 7. Thus, detailed descriptions of the objects assigned the same numbers as those in the example in FIG. 7 are omitted.

Each of switching times 1002, 1004, and 1006 illustrated in a dotted line indicates a time (timing) set in advance at which switching of the distribution image is performed. Further, each of switching start times 1001, 1003, and 1005 indicates a time (timing) at which the switching of the distribution image starts based on each of the settings of the switching times 1002, 1004, and 1006. Each of the switching start times 1001, 1003, and 1005 is determined based on a time period required or that may be used for the switching of the distribution image.

The time required or that may be used for the switching of the distribution image may be set by a user, or may be calculated by an application for implementing the operation of the preset mode.

A transition 1007 of the color temperature setting value illustrates a transition of the color temperature setting value of the distribution image in a case where the above-described control is performed.

As described above, the distribution system 100 according to one or more additional embodiments has the plurality of modes as the switching method of the distribution image. By applying such a configuration to the distribution system 100, it is expected to achieve an effect to reduce the shift of the white balance at the time of the image switching between the plurality of the image capturing apparatuses 101 while reducing the influence of a change in external light from outside the studio using the automatic white balance adjustment to match the switching method of the distribution image by a user.

### One or More Further Embodiments

One or more further embodiments according to the present disclosure will be described below. In addition, since configurations of the distribution system 100 including the image capturing apparatuses 101 according to one or more further embodiments and the image capturing apparatuses 101 according to one or more further embodiments are similar to those according to the aforementioned one or more embodiments, detailed descriptions thereof are omitted.

### Operation(s) of One or More Further Embodiments

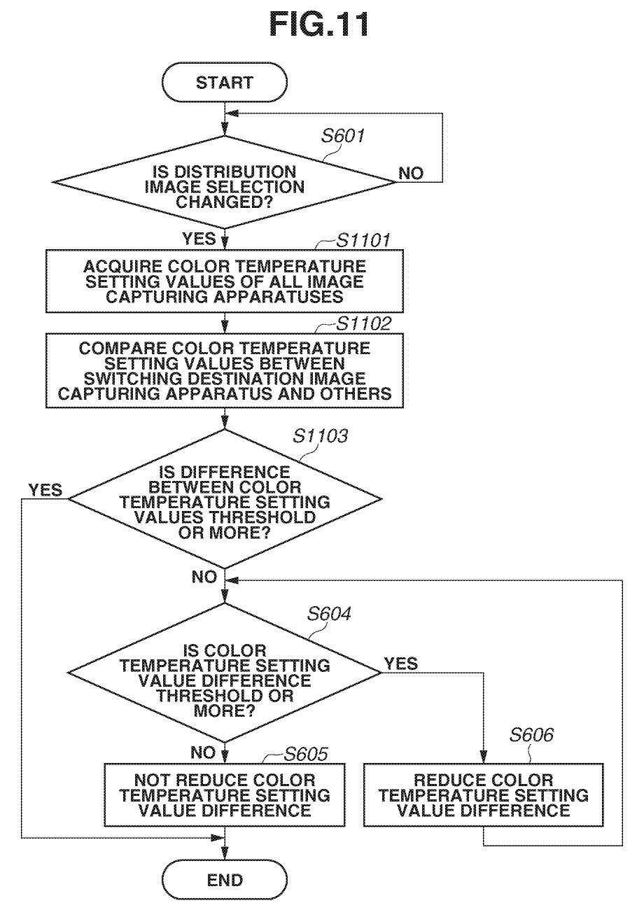

With reference to FIG. 11, an example of processing performed by the distribution system 100 according to one or more further embodiments will be described. A series of the processes illustrated in FIG. 11 is implemented by the CPU 301 or the CPU 401 executing a program stored in the ROM 303 or the ROM 403 and loaded into the RAM 302 or the RAM 402. In addition, detailed descriptions of the processing substantially similar to the processing performed in the example illustrated in FIG. 6 are omitted.

In step S1101, the distribution image selection unit 501 acquires the color temperature set to each of the series of image capturing apparatuses 101 used for the image distribution.

In step S1102, the distribution image selection unit 501 calculates difference values between the color temperature setting value of the switching destination image capturing apparatus 101 and the color temperature setting values of other image capturing apparatuses 101. As a specific example, the distribution image selection unit 501 may calculate the difference value by comparing the color temperature setting value of the switching destination image capturing apparatus 101, and an average value of the color temperature setting values of other image capturing apparatuses 101. Further, as another example, the distribution image selection unit 501 may compare the color temperature setting value of the switching destination image capturing apparatus 101, and the color temperature setting values of the other image capturing apparatuses 101 individually.

In step S1103, the distribution image selection unit 501 determines whether any of the difference values between the color temperature setting values calculated in step S1102 is the threshold value or more.

In step S1103, in a case where the distribution image selection unit 501 determines that the difference value between the color temperature setting values is the threshold value or more (YES in step S1103), the series of processes illustrated in FIG. 11 ends.

On the other hand, in step S1103, in a case where the distribution image selection unit 501 determines that the difference value between the color temperature setting values is less than the threshold value (NO in step S1103), the processing proceeds to step S604. Processing in step S604 and the subsequent steps are the same as those performed in the example described above with reference to FIG. 6.

In addition, for example, the above-described given threshold value may be set based on an instruction from a user via the input apparatus 103 or the input apparatus 108. Further, as another example, the given threshold value may be changed by the application executed by the CPU 301 or the CPU 401 based on the image-capturing scene. In this case, for example, the threshold value may be stored in advance as a table value.

By applying the above-described control to the distribution system 100, it becomes possible to exclude from the switching targets the other image capturing apparatuses 101 with extremely large difference values between the color temperature setting values. In this way, for example, an effect that occurrences of a situation of the distribution image being affected by a local change of the color temperature may be reduced is expected.

### One or More Other Embodiments

The present disclosure may also be realized by processing of supplying a program for implementing one or more functions of the above-described embodiments to a system or an apparatus via a network or a storage medium, and one or more processors in a computer in the system or the apparatus reading and executing the program. Further, the present disclosure may also be realized by a circuit (e.g., application specific integrated circuit (ASIC)) that may implement one or more functions.

Embodiment(s) of the present disclosure may also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the present disclosure, it is possible to reduce shifts of the white balance between a plurality of image capturing apparatuses in a favorable manner, even under a situation in which the image capturing is performed while the plurality of image capturing apparatuses is switched as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2025-038363, filed March 11, 2025, which is hereby incorporated by reference herein in its entirety.

What is claimed is:

1. A control apparatus comprising:
one or more processors that operate to:
select a distribution target image from images captured by a plurality of image capturing apparatuses; and
control a color temperature setting value of at least one of a first image capturing apparatus and a second image capturing apparatus so that a difference value between (i) the color temperature setting value of the first image capturing apparatus that captures an image before switching the distribution target image and (ii) the color temperature setting value of the second image capturing apparatus that captures an image after switching the distribution target image becomes less than a threshold value, based on a selection of the distribution target image.

2. The control apparatus according to claim 1, wherein the one or more processors further operate to control a control interval to change in time-series the color temperature setting value of at least one of the first image capturing apparatus and the second image capturing apparatus so that the difference value between the color temperature setting value of the first image capturing apparatus and the color temperature setting value of the second image capturing apparatus becomes less than the threshold value.

3. The control apparatus according to claim 1, wherein the one or more processors further operate to control a change width of the color temperature setting value in a case where the color temperature setting value of at least one of the first image capturing apparatus and the second image capturing apparatus is changed in time-series so that the difference value between the color temperature setting value of the first image capturing apparatus and the color temperature setting value of the second image capturing apparatus becomes less than the threshold value.

4. The control apparatus according to claim 1, wherein the one or more processors further operate to control the color temperature setting value so that a graph expressing a change in the color temperature setting value over time forms an S-shaped curve, in a case where the color temperature setting value of at least one of the first image capturing apparatus and the second image capturing apparatus is changed in time-series so that the difference value between the color temperature setting value of the first image capturing apparatus and the color temperature setting value of the second image capturing apparatus becomes less than the threshold value.

5. The control apparatus according to claim 1, wherein the one or more processors further operate to switch, in a case where the color temperature setting value of at least one of the first image capturing apparatus and the second image capturing apparatus is changed so that the difference value between the color temperature setting value of the first image capturing apparatus and the color temperature setting value of the second image capturing apparatus becomes less than the threshold value, an operation mode of an image capturing apparatus having the color temperature setting value that is changed from an automatic white balance adjustment mode to a manual white balance adjustment mode.

6. The control apparatus according to claim 1, wherein, as operation modes for controlling the difference value between the color temperature setting value of the first image capturing apparatus and the color temperature setting value of the second image capturing apparatus to be less than the threshold value, the control apparatus has at least two modes including a manual mode in which a user manually determines a switching timing of the distribution image each time, and a preset mode in which the distribution image is switched using a condition set in advance being satisfied, as a trigger.

7. The control apparatus according to claim 6, wherein the one or more processors further operate to start controlling, in a case where the control apparatus operates in the manual mode, the color temperature setting value of at least one of the first image capturing apparatus and the second image capturing apparatus at a timing at which the user issues an instruction operating as a starting point so that the difference value between the color temperature setting value of the first image capturing apparatus and the color temperature setting value of the second image capturing apparatus becomes less than the threshold value.

8. The control apparatus according to claim 6, wherein the one or more processors further operate to start controlling, in a case where the control apparatus operates in the preset mode, the color temperature setting value of at least one of the first image capturing apparatus and the second image capturing apparatus using an occurrence of an event or the condition set in advance as a starting point so that the difference value between the color temperature setting value of the first image capturing apparatus and the color temperature setting value of the second image capturing apparatus becomes less than the threshold value.

9. A control method comprising:
selecting a distribution target image from images captured by a plurality of image capturing apparatuses; and
controlling a color temperature setting value of at least one of a first image capturing apparatus and a second image capturing apparatus so that a difference value between (i) the color temperature setting value of the first image capturing apparatus that captures an image before switching the distribution target image and (ii) the color temperature setting value of the second image capturing apparatus that captures an image after switching the distribution target image becomes less than a threshold value, based on a selection of the distribution target image.

10. A non-transitory computer-readable storage medium storing a program for causing a computer to execute a control method, the control method comprising:
selecting a distribution target image from images captured by a plurality of image capturing apparatuses; and
controlling a color temperature setting value of at least one of a first image capturing apparatus and a second image capturing apparatus so that a difference value between (i) the color temperature setting value of the first image capturing apparatus that captures an image before switching the distribution target image and (ii) the color temperature setting value of the second image capturing apparatus that captures an image after switching the distribution target image becomes less than a threshold value, based on a selection of the distribution target image.
